(19) United States
(12) Patent Application Publication
(10) Pub. No.: US 2017/0210071 A1
(43) Pub. Date: Jul. 27, 2017

(54) THREE-DIMENSIONAL PRINTING DEVICE AND THREE-DIMENSIONAL PRINTING METHOD

(71) Applicant: BOE TECHNOLOGY GROUP CO., LTD., Beijing (CN)

(72) Inventor: Yanbing WU, Beijing (CN)

(21) Appl. No.: 15/328,998

(22) PCT Filed: Sep. 10, 2015
(86) PCT No.: PCT/CN2015/089344

§ 371 Date: Jan. 25, 2017

(30) Foreign Application Priority Data
May 20, 2015 (CN) 201510259631.X

(51) Int. Cl. B29C 67/00; B33Y 30/00; B33Y 50/02; B33Y 10/00

(52) U.S. Cl. CPC B29C 67/0062; B29C 67/0088; B29C 67/0092; B33Y 10/00; B33Y 30/00; B33Y 50/02

(57) ABSTRACT

The present disclosure provides a three-dimensional printing device and a three-dimensional printing method. The device comprises a printing station and a printing trough configured to receive a material for forming a three-dimensional product, the printing station being disposed in the printing trough and configured to bear the three-dimensional product formed after exposure, and further comprises a switch layer, an exposure light source and a control unit, wherein the switch layer is disposed corresponding to a bottom of the printing trough, the exposure light source is disposed corresponding to the switch layer, the control unit is configured to control the exposure light source and the switch layer to be turned on and off, to make the exposure light emitted from the exposure light source pass or not pass, so as to expose the material in the printing trough to form an exposure pattern.

### CROSS REFERENCE TO RELATED APPLICATIONS

This application is a National Stage Entry of PCT/CN2015/089344 filed Sep. 10, 2015, which claims the benefit and priority of Chinese Patent Application No. 201510259631.X filed May 20, 2015. The entire disclosure of each of the above applications is incorporated herein by reference.

### TECHNICAL FIELD

Embodiments of the present disclosure relate to a three-dimensional printing device and a three-dimensional printing method.

### BACKGROUND OF THIS DISCLOSURE

The three-dimensional (3D for short) printing technology is a technology which, based on computer 3D design models, and through a software hierarchical discrete and numerical control forming system, uses a laser beam, a hot melt nozzle or the like, to accumulate and bond special materials layer by layer, such as metal powder, ceramic powder, plastic and cell tissue, finally stacking to form, thus producing a physical products. Different from the traditional manufacturing industry in which raw materials are shaped and cut through mechanical processing such as molding and milling to finally manufacture the finished products, 3D printing transforms a 3D entity into a number of two-dimensional planes and performs manufacturing through processing the materials and stacking the materials layer by layer, which reduces the complexity of manufacturing greatly. This digital manufacturing mode does not require complex processes, large machine tools and a lot of manpower, and can manufacture parts in any shapes directly from computer graphic data, so that the manufacturing can be extended to a wider range of production population.

As illustrated in FIG. 1, the traditional three-dimensional printing device comprises a housing 7, a support 6, a printing station 1, resin materials, a printing trough 2 and a projector 8. Its basic working principle is that the resin materials are placed in the printing trough 2, the resin in the resin materials can be cured by irradiation of light of a certain wavelength, and the printing trough 2 can be penetrated by light of a certain wavelength. The light from the projector 8 irradiates on the printing trough 2, and the output light is light that can cure the resin materials. The printing station 1, disposed on the support 6, can be moved up and down along the support 6. The device is enclosed by the housing 7, to be sealed and shielded from light.

In the traditional printing device, the projector 8 is configured to exposing the materials in the printing trough 2 layer by layer. During the exposure, the projector 8 needs to project the image of every pattern to be exposed, which requires that the projector 8 is connected with another display device that controls the projector 8 to project the displayed image onto the materials in the printing trough 2 during the display, so that the materials are exposed layer by layer.

Using the projector 8 to expose the materials requires the integrated use of the display device and the projector 8, which is complex to be implemented both in structures and in principles, and has a high device cost.

### SUMMARY

To overcome the technical problems existing in the prior art, the present disclosure provides a three-dimensional printing device and a three-dimensional printing method. This three-dimensional printing device can expose the material in the printing trough with more simple structures and principles, so that the three-dimensional printing of this three-dimensional printing device becomes easier, the structures are simplified greatly, and meanwhile the cost of the device is reduced.

The present disclosure provides a three-dimensional printing device, comprising a printing station and a printing trough configured to receive the material for forming three-dimensional product, the printing station being disposed in the printing trough and configured to bear the three-dimensional product formed after exposure, and further comprising a switch layer, an exposure light source and a control unit, wherein the switch layer is disposed corresponding to a bottom of the printing trough, the exposure light source is disposed corresponding to the switch layer, the control unit is configured to control the exposure light source and the switch layer to be turned on and off, to make the exposure light emitted from the exposure light source pass or not pass, so as to expose the material in the printing trough to form an exposure pattern.

In an embodiment of the present disclosure, the switch layer is positioned below the printing trough, the exposure light source is positioned below the switch layer, and the light emitted from the exposure light source can penetrate the bottom of the printing trough.

In an embodiment of the present disclosure, the switch layer comprises a transparent substrate and a plurality of switching elements disposed on the transparent substrate, each of the switching element is configured to be turn on and off independently under the control of the control unit, making the exposure light emitted from the exposure light source pass or not pass, and the transparent substrate is parallel to the bottom of the printing trough.

In an embodiment of the present disclosure, the plurality of switching elements are the same in size and shape, and are evenly disposed in a matrix.

In an embodiment of the present disclosure, the switch layer is an LCD panel, a micro-electromechanical panel, an electrochromic panel or an electrowetting panel; the switching elements are subpixels of the LCD panel, the micro-electromechanical panel, the electrochromic panel or the electrowetting panel.

In an embodiment of the present disclosure, the exposure light source comprises a plurality of light sources and a light mixing device, the plurality of light sources are evenly distributed on the side of the light mixing device facing away from the switch layer;

or the plurality of light sources are distributed corresponding to the edges of the light mixing device and the light-emitting surfaces of the plurality of light sources are disposed facing the end surfaces of the edges of the light mixing device;

the light mixing device is parallel to the transparent substrate, for uniformly mixing the light emitted from the plurality of light sources.

In an embodiment of the present disclosure, this three-dimensional printing device further comprises a support, wherein the support is movably connected with the printing station, the printing station is connected with the control unit, and the printing station can move along the support in the direction away from or toward the printing trough under the control of the control unit;

the control unit is configured to control the switch layer and the exposure light source to expose the material in the printing trough layer by layer, so as to form the three-dimensional product;

the control unit is further configured to control the printing station to move a distance of the thickness of a layer of the material along the support in the direction away from the printing trough after the completion of exposure of the material in the preceding layer.

In an embodiment of the present disclosure, the control unit is configured to control the switching elements to be turned on or off row by row, so as to make the material be exposed layer by layer to form the exposure pattern.

In an embodiment of the present disclosure, the control unit is configured to control the exposure light source to be turned off before scanning of the first row on the switch layer corresponding to the exposure pattern of the material of each layer starts; and to control the exposure light source to be turned on after scanning of the switch layer corresponding to the exposure pattern of the material of the layer is completed and to keep the exposure light source on until exposure of the material of the layer is completed.

In an embodiment of the present disclosure, the time from the completion of exposure of the material in the preceding layer to the completion of scanning of the switch layer corresponding to the exposure pattern of the material in the subsequent layer is a first time period; and the time of the printing station moving a distance of the thickness of a layer of the material is a second time period;

the control unit is further configured to compare the first time period with the second time period to determine if the first time period is greater than or equal to the second time period, if the determination result is YES, to control the exposure light source to be turned on after exposure of the material in the preceding layer is completed and with an elapse of the first time period, so as to expose the material in the subsequent layer; and if the determination result is NO, to control the exposure light source to be turned on after exposure of the material in the preceding layer is completed and with an elapse of the second time period, so as to expose the material in the subsequent layer.

In an embodiment of the present disclosure, the control unit is configured to control the switching elements to be turned on or off frame by frame, so as to make the material be exposed layer by layer to form an exposure pattern.

In an embodiment of the present disclosure, the control unit is configured to control the exposure light source to be turned off after the completion of exposure of the material in the preceding layer; and to control the exposure light source to be turned on after an interval in which the printing station moves a distance of the thickness of a layer of the material, so as to expose the material in the subsequent layer.

In an embodiment of the present disclosure, the three-dimensional printing device further comprises a housing, wherein the housing is sealed, and the printing station, the printing trough, the switch layer, the exposure light source and the control unit are all disposed within the housing.

The present disclosure also provides a three-dimensional printing method, comprising: a switch layer and an exposure light source exposing material in a printing trough layer by layer, and after the completion of exposure of the material in the preceding layer, a printing station moving a distance of the thickness of a layer of the material in the direction away from the printing trough; then the switch layer and the exposure light source continuing to expose the material in the subsequent layer until a three-dimensional product is formed by the layer-by-layer exposure.

In an embodiment of the present disclosure, the switch layer is turned on or off row by row, or the switch layer is turned on or off frame by frame, so as to expose the material layer by layer to form an exposure pattern.

In an embodiment of the present disclosure, in the process of the material being exposed layer by layer through turning on or off the switch layer row by row, the exposure light source is turned off before scanning of the first row on the switch layer corresponding to the exposure pattern of the material of each layer starts, and the exposure light source is turned on after scanning of the switch layer corresponding to the exposure pattern of the material of the layer is completed, and the exposure light source is kept on until exposure of the material of the layer is completed.

In an embodiment of the present disclosure, in the process of the three-dimensional product being exposed layer by layer, the time from the completion of exposure of the material in the preceding layer to the completion of scanning of the switch layer corresponding to the exposure pattern of the material in the subsequent layer is a first time period, and the time of the printing station moving a distance of the thickness of a layer of the material is a second time period;

if the first time period is greater than to equal to the second time period, after exposure of the material in the preceding layer is completed and with an elapse of the first time period, the exposure light source is turned on and the material in the subsequent layer begins to be exposed;

if the first time period is less than the second time period, after exposure of the material in the preceding layer is completed and with an elapse of the second time period, the exposure light source is turned on, and the material in the subsequent layer begins to be exposed.

In an embodiment of the present disclosure, in the process of the material being exposed layer by layer through turning on or off the switch layer frame by frame, the exposure light source is turned off after the completion of exposure of the material in the preceding layer; and the exposure light source is turned on after an interval in which the printing station moves a distance of the thickness of a layer of the material, and the material in the subsequent layer begins to be exposed.

The beneficial effects of the present disclosure are as follows: the three-dimensional printing device provided in the present disclosure can expose the material in the printing trough with more simple structures and principles by configuring the switch layer, the exposure light source and the control unit, so that the three-dimensional printing of the three-dimensional printing device becomes easier, the structures are simplified greatly, and meanwhile the cost of the device is reduced.

### BRIEF DESCRIPTION OF THE DRAWINGS

To illustrate the technical solutions of embodiments of the present disclosure more clearly, the following will briefly introduce the drawings of the embodiments. Apparently the drawings in the following description only relate to some embodiments of the present disclosure, instead of limiting the present disclosure.

FIG. 1 is a schematic structural view of a three-dimensional printing device in the prior art;

FIG. 2 is a schematic structural view of a three-dimensional printing device in embodiment 1 of the present disclosure;

FIG. 3 is a flow diagram of a three-dimensional printing method in the embodiment 1 of the present disclosure.

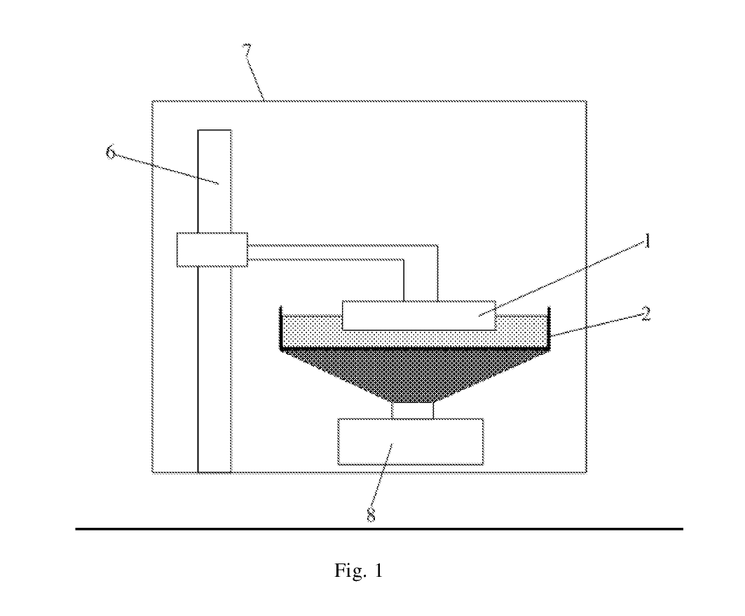

### DETAILED DESCRIPTION OF EXEMPLARY EMBODIMENTS

To facilitate a person skilled in the art better understanding the technical solutions of the present disclosure, the following further describes a three-dimensional printing device and a three-dimensional printing method provided in embodiments of the present disclosure in detail in conjunction with the drawings and specific embodiments. Apparently the described embodiments are some embodiments of the present disclosure, instead of all the embodiments. Based on the described embodiments of the present disclosure, all other embodiments obtained by those of ordinary skill in the art without inventive effort are within the scope of the present disclosure.

### Embodiment 1

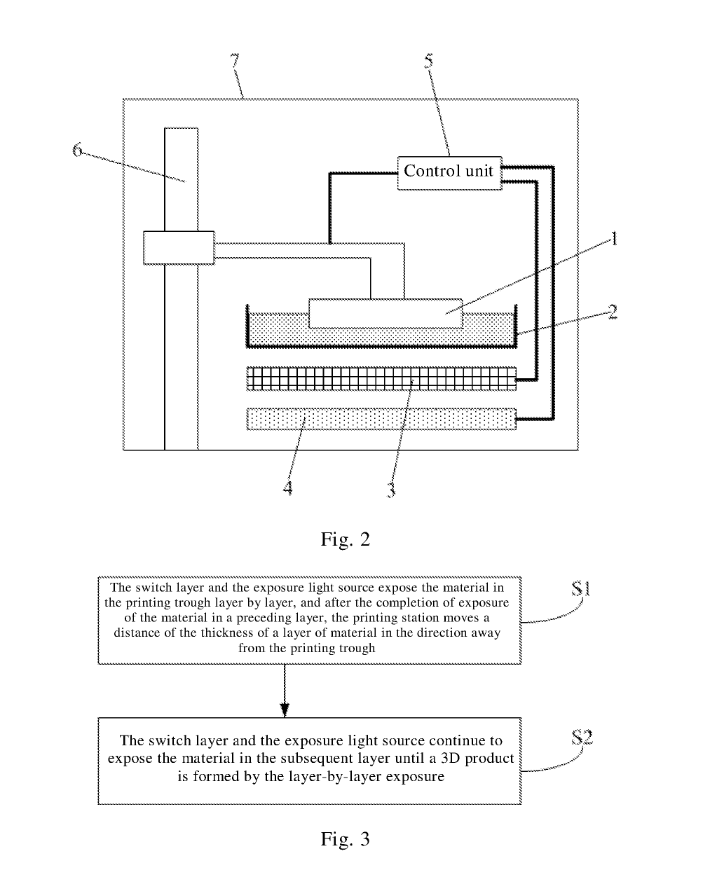

This embodiment provides a three-dimensional printing device, as illustrated in FIG. 2, comprising a printing station 1 and a printing trough 2 configured to receive a material for forming a three-dimensional product, the printing station 1 being disposed in the printing trough 2 and configured to bear the three-dimensional product formed after exposure, and further comprising a switch layer 3, an exposure light source 4 and a control unit 5, wherein the switch layer 3 is disposed corresponding to a bottom of the printing trough; the exposure light source 4 is disposed corresponding to the switch layer 3; the control unit 5 can control the exposure light source 4 and the switch layer 3 to be turned on and off, to make the exposure light emitted from the exposure light source 4 pass or not pass, so that the material in the printing trough 2 is exposed to form an exposure pattern.

The switch layer 3, the exposure light source 4 and the control unit 5 can be configured to make this three-dimensional printing device expose the material in the printing trough 2 with more simple structures and principles, so that the three-dimensional printing of this three-dimensional printing device becomes easier, the structures are simplified greatly, and meanwhile the cost of the device is reduced.

In this embodiment, the switch layer 3 is positioned below the printing trough 2, the exposure light source 4 is positioned below the switch layer 3, and the light emitted from the exposure light source 4 can penetrate the bottom of the printing trough 2. That is, the exposure light emitted from the exposure light source 4 can penetrate the turned-on switch layer 3 to irradiate on the bottom of the printing trough 2, and then penetrate the bottom of the printing trough 2 to irradiate on the material, so as to expose the material.

In this embodiment, the switch layer 3 comprises a transparent substrate and a plurality of switching elements disposed on the transparent substrate, each of the switching element can be turn on and off independently under the control of the control unit, making the exposure light emitted from the exposure light source 4 pass or not pass; the transparent substrate is parallel to the bottom of the printing trough 2. Such an arrangement can ensure that the distance between any one switching element and the bottom of the printing trough 2 is equal, to ensure that the light penetrating the switching elements can irradiate on the material in the printing trough 2 simultaneously, so that the exposure can be more accurate.

In this embodiment, the plurality of switching elements are the same in size and shape, and they are evenly arranged in a matrix. Such an arrangement can not only make the switching elements be turned on and off to form various exposure patterns, but also make the exposure light penetrating the switching elements more evenly, so that the exposure of the material area to be exposed by the exposure light source 4 is more evenly and the exposure quality is improved.

In this embodiment, the switch layer 3 is an LCD panel, a micro-electromechanical panel, an electrochromic panel or an electrowetting panel. The switching elements are subpixels of the LCD panel, the micro-electromechanical panel, the electrochromic panel or the electrowetting panel.

It should be noted that the LCD panel, the micro-electromechanical panel, the electrochromic panel and the electrowetting panel do not include backlights. The structures of the LCD panel, the micro-electromechanical panel, the electrochromic panel and the electrowetting panel and the principle of turning on and off of their subpixels are the same as those in the prior art, so they are not described in detail here.

Since the switch layer 3 adopts an LCD panel, a micro-electromechanical panel, an electrochromic panel or an electrowetting panel, the thickness of the switch layer 3 is the thickness of the LCD panel, the micro-electromechanical panel, the electrochromic panel or the electrowetting panel, so that the switch layer 3 will not take up too much space. Compared with the prior art solution adopting a projector, the configuration of the switch layer 3 reduces the volume of the three-dimensional printing device greatly, making it more convenient to use and carry.

In this embodiment, the exposure light source 4 comprises a plurality of light sources and a light mixing device, the plurality of light sources are distributed evenly on the side of the light mixing device facing away from the switch layer 3; and the light mixing device is parallel to the transparent substrate for uniformly mixing the light emitted from the plurality of light sources. Such an arrangement can make the light emitted from the light sources mixed uniformly after passing through the light mixing device, so that the exposure light passing through the switch layer 3 can be more even, and thus exposure of the material area to be exposed by the exposure light source 4 is more even and the exposure quality is improved. Here, the light mixing device can adopt a light guide plate, that is, the exposure light source 4 in this embodiment is equivalent to a direct-lit backlight of an LCD panel.

It should be noted that the plurality of light sources can be distributed corresponding to the edges of the light mixing device, and the light-emitting surfaces of the plurality of light sources can be disposed facing the end surfaces of the edges of the light mixing device, that is, the exposure light source 4 in this embodiment is equivalent to a side-lit backlight of an LCD panel. Such an arrangement can similarly make the light emitted from the light source mixed uniformly after passing through the light mixing device, so that the exposure light passing through the switch layer 3 can be more even.

The light mixing device is parallel to the transparent substrate, which makes the space occupied by the entirety of the exposure light source 4 and the switch layer 3 far smaller than the space occupied by the entirety of the integrated projector and display device in the prior art, so that the volume of the three-dimensional printing device is reduced greatly, making it more convenient to use and carry.

In this embodiment, the three-dimensional printing device further comprises a support 6, the support 6 is movably connected with the printing station 1, the printing station 1 is connected with the control unit 5, the printing station 1 can move along the support 6 in the direction away from or toward the printing trough 2 under the control of the control unit 5; the control unit 5 is configured to control the switch layer 3 and the exposure light source 4 to expose the material in the printing trough 2 layer by layer, so as to form a three-dimensional product. The control unit 5 is further configured to control the printing station 1 to move a distance of the thickness of a layer of the material along the support 6 in the direction away from the printing trough 2 after the completion of exposure of the material in the preceding layer. Such an arrangement can make the three-dimensional printing device expose the material in the printing trough 2 layer by layer, so that the three-dimensional product formed by the exposure will be more accurate.

In this embodiment, the control unit 5 is configured to control the switching elements to be turned on or off row by row, to make the material be exposed layer by layer to form the exposure pattern. That is, the switching elements are controlled in the manner of line-by-line scanning to form the exposure pattern of the material of each layer.

In this embodiment, the control unit 5 is configured to control the exposure light source 4 to be turned off before scanning of the first row on the switch layer 3 corresponding to the exposure pattern of the material of each layer starts; and to control the exposure light source 4 to be turned on after scanning of the switch layer 3 corresponding to the exposure pattern of the material of the layer is completed and to keep the exposure light source 4 on until exposure of the material of the layer is completed. That is, before starting scanning the first row on the switch layer 3 corresponding to the exposure pattern of the material of each layer, the exposure light source 4 keeps off, and the control unit 5 controls the switching elements to be turned on or off row by row, and the exposure light source 4 will not be turned on until the switching elements are turned on or off row by row to form a complete exposure pattern corresponding to the material of the layer. Such an arrangement can not only relatively shorten the exposure time of the material of each layer, but also can prevent the mistaken exposure in the time period from the end of exposure of the material in a preceding layer to the start of exposure of the material in a subsequent layer (that is, when the exposure of the material in the subsequent layer starts, the exposure pattern of the material in the preceding layer may not have completely ended, which leads to the mistaken exposure of the material in the subsequent layer), so that the printing of the three-dimensional printing device is more accurate and the exposure effect is better.

In this embodiment, the time from the completion of exposure of the material in the preceding layer to the completion of scanning of the switch layer 3 corresponding to the exposure pattern of the material in the subsequent layer is the first time period; the time of the printing station moving a distance of the thickness of a layer of the material is the second time period, the control unit 5 is further configured to compare the first time period with the second time period to determine if the first time period is greater than or equal to the second time period, if the determination result is YES, to control the exposure light source 4 to be turned on after exposure of the material in the preceding layer is completed and with an elapse of the first time period, so as to expose the material in the subsequent layer; and if the determination result is NO, to control the exposure light source 4 to be turned on after exposure of the material in the preceding layer is completed and with an elapse of the second time period, so as to expose the material in the subsequent layer. Such an arrangement can prevent the mistaken exposure of the material in the subsequent layer in the time period from the end of exposure of the material in the preceding layer to the start of exposure of the material in the subsequent layer, caused by that when the printing station 1 has not yet moved a distance of the thickness of a layer of the material, the exposure of the material in the subsequent layer starts (that is, after the completion of exposure of the material in the preceding layer, the printing station 1 moves a distance of the thickness of a layer of the material in the direction away from the printing trough 2, and if the exposure light source 4 is turned on before the movement of the printing station 1 has been completed, a mistaken exposure will be generated), so that the printing of the three-dimensional printing device is more accurate and the exposure effect is better.

In this embodiment, the three-dimensional printing device further comprises a housing 7, the housing 7 is sealed, the printing station 1, the printing trough 2, the switch layer 3, the exposure light source 4 and the control unit 5 are all disposed within the housing 7. The arrangement of the housing 7 can make the exposure be performed in a sealed environment shielded from light, so that the utilization of the exposure light is improved and the quality of the exposure is improved.

This embodiment further provides a three-dimensional printing method, as illustrated in FIG. 3, comprising: step S1, the switch layer and the exposure light source expose the material in the printing trough layer by layer, and after the completion of exposure of the material in the preceding layer, the printing station moves a distance of the thickness of a layer of the material in the direction away from the printing trough; then step S2 is performed, the switch layer and the exposure light source continue to expose the material in the subsequent layer until the layer-by-layer exposure forms a three-dimensional product.

In this embodiment, the switch layer is turned on or off row by row, to make the material be exposed layer by layer to form the exposure pattern. In the process of the material being exposed layer by layer through turning on or off the switch layer row by row, the exposure light source is turned off before starting scanning of the first row on the switch layer corresponding to the exposure pattern of the material of each layer; and the exposure light source is turned on after scanning of the switch layer corresponding to the exposure pattern of the material of the layer is completed, and the exposure light source is kept on until exposure of the material of the layer is completed. In this way, not only the exposure time of the material of each layer can be shortened relatively, but also the mistaken exposure in the time period from the end of exposure of the material in the preceding layer to the start of exposure of the material in the subsequent layer (that is, when the exposure of the material in the subsequent layer starts, the exposure pattern of the material in the preceding layer may not have completely ended, which leads to mistaken exposure of the material in the subsequent layer) can be prevented, so that the printing of this three-dimensional printing device is more accurate and the exposure effect is better.

In this embodiment, in the layer-by-layer exposure of the three-dimensional product, the time from the completion of exposure of the material in the preceding layer to the completion of scanning of the switch layer corresponding to the exposure pattern of the material of subsequent layer is a first time period; the time of the printing station moving a distance of the thickness of a layer of the material is a second time period; if the first time period is greater than or equal to the second time period, after exposure of the material in the preceding layer is completed and with an elapse of the first time period, the exposure light source is turned on and the material in the subsequent layer begins to be exposed; if the first time period is less than the second time period, after exposure of the material in the preceding layer is completed and with an elapse of the second time period, the exposure light source is turned on and the material in the subsequent layer begins to be exposed. This can prevent the mistaken exposure of the material in the subsequent layer in the time period from the end of exposure of the material in the preceding layer to the start of exposure of the material in the subsequent layer, caused by that when the printing station has not yet moved a distance of the thickness of a layer of the material, the exposure of the material in the subsequent layer starts (that is, after the end of exposure of the material in the preceding layer, the printing station moves a distance of the thickness of a layer of the material in the direction away from the printing trough, and if the exposure light source is turned on before the movement of the printing station has been completed, a mistaken exposure will be generated), so that the printing of this three-dimensional printing device is more accurate and the exposure effect is better.

### Embodiment 2

This embodiment provides a three-dimensional printing device, and different from the embodiment 1, the control unit is configured to control the switching elements to be turned on or off frame by frame, to make the material be exposed layer by layer to form an exposure pattern. That is, the switching elements are controlled in the manner of frame-by-frame scanning to form an exposure pattern of the material of each layer.

In this embodiment, the control unit is configured to control the exposure light source to be turned off after the completion of exposure of the material in the preceding layer, and to control the exposure light source to be turned on after an interval in which the printing station moves a distance of the thickness of a layer of the material, so as to expose the material in the subsequent layer. Such an arrangement can not only relatively shorten the exposure time of the material of each layer, preventing mistaken exposure in the time period from the end of exposure of the material in the preceding layer to the start of exposure of the material in the subsequent layer, but also can prevent mistaken exposure of the material in the subsequent layer in the time period from the end of exposure of the material in the preceding layer to the start of exposure of the material in the subsequent layer, caused by that when the printing station has not yet moved a distance of the thickness of a layer of the material, the exposure of the material in the subsequent layer starts, so that the printing of this three-dimensional printing device is more accurate and the exposure effect is better.

The other structures of the three-dimensional printing device in this embodiment are the same as those in the embodiment 1, so they will not be described in detail here.

This embodiment further provides a three-dimensional printing method, and different from the three-dimensional printing method in the embodiment 1, the switch layer is turned on or off frame by frame, to make the material be exposed layer by layer to form an exposure pattern. In the process of the material being exposed layer by layer through turning on or off the switch layer frame by frame, the exposure light source is turned off after the completion of exposure of the material in the preceding layer, and the exposure light source is turned on after an interval in which the printing station moves a distance of the thickness of a layer of the material, and the material in the subsequent layer begins to be exposed.

The three-dimensional printing method in this embodiment can not only relatively shorten the exposure time of the material of each layer, preventing mistaken exposure in the time period from the end of exposure of the material in the preceding layer to the start of exposure of the material in the subsequent layer; but also can prevent mistaken exposure of the material in the subsequent layer in the time period from the end of exposure of the material in the preceding layer to the start of exposure of the material in the subsequent layer, caused by that when the printing station has not yet moved a distance of the thickness of a layer of the material, the exposure of the material in the subsequent layer starts, so that the printing of this three-dimensional printing device is more accurate and the exposure effect is better.

The other steps of the three-dimensional printing method in this embodiment are the same as those in the embodiment 1, so they are not described in detail here.

The beneficial effects of the embodiments 1-2 are as follows: the three-dimensional printing device provided in the embodiments 1-2 can be made to expose the material in the printing trough with more simple structures and principles by configuring the switch layer, the exposure light source and the control unit, so that the three-dimensional printing of this three-dimensional printing device becomes easier, the structures are simplified greatly, and meanwhile the cost of the device is reduced.

It should be understood that the above embodiments are only exemplary embodiments for illustrating the principles of the present disclosure, however, the present disclosure is not limited thereto. It is apparent to those of ordinary skill in the art that various changes and modifications can be made without departing from the spirit and essential attributes of the present disclosure, and these changes and modifications are contemplated to be within the scope of the present disclosure.

1. A three-dimensional printing device, comprises a printing station and a printing trough configured to receive a material for forming a three-dimensional product, the printing station being disposed in the printing trough and configured to bear the three-dimensional product formed after exposure, and further comprising a switch layer, an exposure light source and a control unit, wherein the switch layer is disposed corresponding to a bottom of the printing trough; the exposure light source is disposed corresponding to the switch layer; the control unit is configured to control the exposure light source and the switch layer to be turned on and off, to make the exposure light emitted from the exposure light source pass or not pass, so as to expose the material in the printing trough to form an exposure pattern.

2. The three-dimensional printing device of claim 1, wherein the switch layer is positioned below the printing trough, the exposure light source is positioned below the switch layer, and the light emitted from the exposure light source can penetrate the bottom of the printing trough.

3. The three-dimensional printing device of claim 2, wherein the switch layer comprises a transparent substrate and a plurality of switching elements disposed on the transparent substrate, each of the switching element is configured to be turned on and off independently under the control of the control unit, making the exposure light emitted from the exposure light source pass or not pass, and the transparent substrate is parallel to the bottom of the printing trough.

4. The three-dimensional printing device of claim 3, wherein the plurality of switching elements are the same in size and shape, and are arranged evenly in a matrix.

5. The three-dimensional printing device of claim 4, wherein the switch layer is an LCD panel, a micro-electromechanical panel, an electrochromic panel or an electrowetting panel; the switching elements are subpixels in the LCD panel, the micro-electromechanical panel, the electrochromic panel or the electrowetting panel.

6. The three-dimensional printing device of claim 3, wherein the exposure light source comprises a plurality of light sources and a light mixing device, the plurality of light sources are evenly distributed on the side of the light mixing device facing away from the switch layer;
or the plurality of light sources are distributed corresponding to the edges of the light mixing device and the light-emitting surfaces of the plurality of light sources are disposed facing the end surfaces of the edges of the light mixing device;
the light mixing device is parallel to the transparent substrate, for uniformly mixing the light emitted from the plurality of light sources.

7. The three-dimensional printing device of claim 5, further comprising a support, wherein, the support is movably connected with the printing station, the printing station is connected with the control unit, and the printing station can move along the support in the direction away from or toward the printing trough under the control of the control unit;
the control unit is configured to control the switch layer and the exposure light source to expose the material in the printing trough layer by layer, so as to form the three-dimensional product;
the control unit is further configured to control the printing station to move a distance of the thickness of a layer of the material along the support in the direction away from the printing trough after the completion of exposure of the material in the preceding layer.

8. The three-dimensional printing device of claim 7, wherein the control unit is configured to control the switching elements to be turned on or off row by row, so as to make the material be exposed layer by layer to form the exposure pattern.

9. The three-dimensional printing device of claim 8, wherein the control unit is configured to control the exposure light source to be turned off before scanning of the first row on the switch layer corresponding to the exposure pattern of the material of each layer starts, and to control the exposure light source to be turned on after scanning of the switch layer corresponding to the exposure pattern of the material of the layer is completed and to keep the exposure light source on until exposure of the material of the layer is completed.

10. The three-dimensional printing device of claim 9, wherein the time from the completion of exposure of the material in the preceding layer to the completion of scanning of the switch layer corresponding to the exposure pattern of the material in the subsequent layer is a first time period, and the time of the printing station moving a distance of the thickness of a layer of the material is a second time period;
the control unit is further configured to compare the first time period with the second time period to determine if the first time period is greater than or equal to the second time period, if the determination result is YES, to control the exposure light source to be turned on after exposure of the material in the preceding layer is completed and with an elapse of the first time period, so as to expose the material in the subsequent layer; and if the determination result is NO, to control the exposure light source to be turned on after exposure of the material in the preceding layer is completed and with an elapse of the second time period, so as to expose the material in the subsequent layer.

11. The three-dimensional printing device of claim 7, wherein the control unit is configured to control the switching elements to be turned on or off frame by frame, so as to make the material be exposed layer by layer to form an exposure pattern.

12. The three-dimensional printing device of claim 11, wherein the control unit is configured to control the exposure light source to be turned off after the completion of exposure of the material in the preceding layer, and to control the exposure light source to be turned on after an interval in which the printing station moves a distance of the thickness of a layer of the material, so as to expose the material in the subsequent layer.

13. The three-dimensional printing device of claim 1, further comprising a housing, wherein the housing is sealed, and the printing station, the printing trough, the switch layer, the exposure light source and the control unit are all disposed within the housing.

14. A three-dimensional printing method, comprising:
a switch layer and an exposure light source exposing material in a printing trough layer by layer, and after the completion of exposure of the material in a preceding layer, a printing station moving a distance of the thickness of a layer of the material in the direction away from the printing trough; then the switch layer and the exposure light source continuing to expose the material in a subsequent layer until a three-dimensional product is formed by the layer-by-layer exposure.

15. The three-dimensional printing method of claim 14, wherein, the switch layer is turned on or off row by row, or the switch layer is turned on or off frame by frame, so as to expose the material layer by layer to form an exposure pattern.

16. The three-dimensional printing method of claim 15, wherein, in the process of the material being exposed layer by layer through turning on or off the switch layer row by row, the exposure light source is turned off before scanning of the first row on the switch layer corresponding to the exposure pattern of the material of each layer starts, and the exposure light source is turned on after scanning of the switch layer corresponding to the exposure pattern of the material of the layer is completed, and the exposure light source is kept on until exposure of the material of the layer is completed.

17. The three-dimensional printing method of claim 16, wherein in the process of the three-dimensional product being exposed layer by layer, the time from the completion of exposure of the material in the preceding layer to the completion of scanning of the switch layer corresponding to the exposure pattern of the material in the subsequent layer is a first time period, and the time of the printing station moving a distance of the thickness of a layer of the material is a second time period;
if the first time period is greater than or equal to the second time period, after exposure of the material in the preceding layer is completed and with an elapse of the first time period, the exposure light source is turned on, and the material in the subsequent layer begins to be exposed;
if the first time period is less than the second time period, after exposure of the material in the preceding layer is completed and with an elapse of the second time period, the exposure light source is turned on, and the material in the subsequent layer begins to be exposed.

18. The three-dimensional printing method of claim 15, wherein in the process of the material being exposed layer by layer through turning on or off the switch layer frame by frame, the exposure light source is turned off after the completion of exposure of the material in the preceding layer, and the exposure light source is turned on after an interval in which the printing station moves a distance of the thickness of a layer of the material, and the material in the subsequent layer begins to be exposed.

19. The three-dimensional printing device of claim 2, further comprising a housing, wherein the housing is sealed, and the printing station, the printing trough, the switch layer, the exposure light source and the control unit are all disposed within the housing.

20. The three-dimensional printing device of claim 3, further comprising a housing, wherein the housing is sealed, and the printing station, the printing trough, the switch layer, the exposure light source and the control unit are all disposed within the housing.
